(19) United States
(12) Patent Application Publication
(10) Pub. No.: US 2018/0246440 A1
(43) Pub. Date: Aug. 30, 2018

(54) IMAGE FORMING APPARATUS

(71) Applicant: Oki Data Corporation, Tokyo (JP)

(72) Inventor: Yuji TAKINO, Tokyo (JP)

(21) Appl. No.: 15/899,616

(22) Filed: Feb. 20, 2018

(30) Foreign Application Priority Data
Feb. 28, 2017 (JP) 2017-035816

(51) Int. Cl. G03G 9/00

(52) U.S. Cl. CPC G03G 15/0832; G03G 15/0216; G03G 15/2053; G03G 15/0189; G03G 15/0121

(57) ABSTRACT

Developer includes toner containing binder resin. A toner cartridge 12 contains the developer. A developing roller 5 carries the developer and supplies the developer to a photosensitive drum 3. The developer has melting-point temperature (T½) in the range of 129.6° C.≤T½≤149.4° C. and a gel fraction in the range of 8.1%≤gel fraction≤57.1%.

### FIELD

The present invention relates to an image forming apparatus such as a copier or a printer for electrophotography, and more specifically, to an image forming apparatus using developer for a specific purpose.

### BACKGROUND

In recent years, image forming apparatuses are desired to support multiple media in order to print on special media such as label paper, waterproof paper, media for printing on T-shirts as well as ordinary paper for typical office use. There is a known technique for printing on T-shirt print paper by an image forming apparatus, which is disclosed in Japanese Patent Application Publication No. 2011-152662 (page 6, FIG. 5).

### SUMMARY

### Technical Problem

However, since a sheet made of resin or the like that functions as adhesive is used on the T-shirt print medium such as paper, the conventional technique gives unintended adhesion at the point of adhesion to the toner, and thereby reducing printing quality on the T-shirt. Especially, there is a problem in which unequal adhesion force between the interfaces of toner and the T-shirt print medium causes the toner not to be well transferred onto the T shirt, thereby resulting in a white void, which is non-conformance where white dots are occurred in the toner image, or an adhesive residue, which is non-conformance where toner is left on the T-shirt print medium after the transfer.

### Solution to Problem

A developing device has developer that includes toner containing binder resin; a developer container that contains the developer; and a developer carrier that carries the developer and supplies the developer to an image carrier. The developer has melting-point temperature (T½) in the range of 129.6° C.≤T½≤149.4° C. and a gel fraction in the range of 8.1%≤gel fraction≤57.1%.

### Advantageous Effects of Invention

According to one or more aspects of the present invention, phenomena of a white void and an adhesive residue can be improved, and good printing can be performed on T-shirts and other special media.

### BRIEF DESCRIPTION OF DRAWINGS

FIG. 1 is a main-part configuration diagram illustrating a main-part configuration of a printer as an image forming apparatus in a first embodiment.

FIG. 2 is a main-part configuration diagram illustrating a main-part configuration of an image forming unit.

FIG. 3 is a block diagram illustrating a main-part configuration of a control system of the printer.

FIG. 4 is a diagram schematically illustrating the processing in measurement steps of gel fraction measurement of the toner.

FIG. 5 is a diagram illustrating measurement positions of a solid 100% duty pattern on an M-sheet.

FIG. 6(A) illustrates a configuration of a printed M-sheet, FIG. 6(B) illustrates transfer from the M-sheet to a T-sheet, and FIG. 6(C) shows transfer from the T-sheet to a T-shirt.

FIG. 7 is a diagram representing a table listing the evaluation results.

### DESCRIPTION OF EMBODIMENTS

### First Embodiment

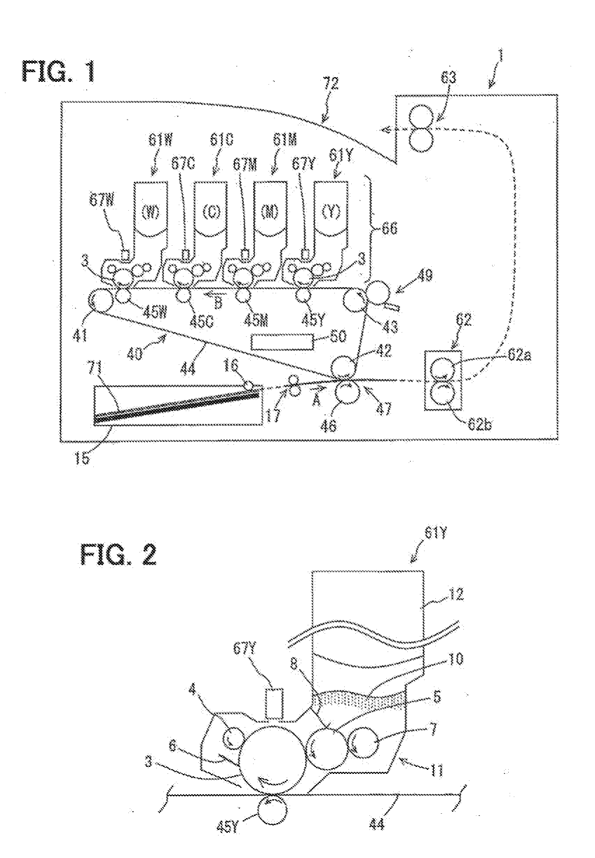

FIG. 1 is a main-part configuration diagram illustrating a main-part configuration of a printer 1 as an image forming apparatus in a first embodiment.

The printer 1 has a configuration of a color intermediate-transfer electrophotographic printer that can print four colors, which are fluorescent yellow (Y), fluorescent magenta (M), fluorescent cyan (C), and fluorescent white (W). As shown in the figure, a paper cassette 15 contains a plurality of sheets of recording paper 71 as a stack of recording media, and a hopping roller 16 takes a sheet of the recording paper 71 from the paper cassette 15 and sends it to the transfer path. In the downstream side of the hopping roller 16 in the direction of arrow A representing the direction of transfer of the recording paper 71, a pair of resist rollers 17 that correct the skew of the sheet of the recording paper 71 is disposed and sends the sheet of the recording paper 71 to a secondary transfer section 47 at predetermined timing.

A image forming section 66 includes four image forming units 61Y, 61M, 61C, 61W (when each of them does not need distinguishing, each of them is denoted simply by a numeral 61) and four LED heads 67Y, 67M, 67C, 67W (when each of them does not need distinguishing, each of them is denoted simply by a numeral 67). Each of the forming units 61Y, 61M, 61C, 61W forms toner images each of the fluorescent yellow (Y), fluorescent magenta (M), fluorescent cyan (C), and fluorescent white (W). The four image forming units 61Y to 61W are disposed in that order from the upstream side in the direction of arrow B representing the travelling direction of an intermediate transfer belt 44, which is included in an intermediate transfer belt unit 40 as will be described later and moves in the upper part of the intermediate transfer belt unit 40, and each of the four LED heads 67Y to 67W are disposed to face each of the image forming units 61Y to 61W so that it may throw light into a predetermined part of a photosensitive drum 3 provided in the image forming unit 61, as described later.

Hereafter, yellow (Y), magenta (M), cyan (C), and white (W) will sometimes be denoted as just (Y), (M), (C), and (W).

Since internal structures of these image forming units 61 are identical, the image forming unit 61Y for yellow (Y) will be taken as an example, and the identical internal structure will be described. FIG. 2 is a main-part configuration diagram illustrating a main-part configuration of the image forming unit 61Y.

As shown in the figure, the image forming unit 61 includes a developing device 11 and a toner cartridge 12 as a developer container. The developing device 11 includes a photosensitive drum 3 as an image carrier, a charging roller 4 as a charging member for charging the photosensitive drum 3, a developing roller 5 as a rotatable developer carrier disposed to face the photosensitive drum 3, a supply roller 7 that supplies toner 10 as developer to the developing roller 5 and collects unused toner from the developing roller 5, a regulation blade 8 that forms a thin layer of toner on the developing roller 5, and a cleaning blade 6 that collects toner left untransferred on the photosensitive drum 3. In the first embodiment, the toner 10 is made up of the developer, but the toner 10 and carriers, which supply the toner with electric charges and have magnetism for forming toner images on the photosensitive 3 by carrying the toner 10 to the photosensitive 3, may be made up of the developer.

In the vicinity of the cleaning blade 6, a space for keeping waste toner scraped off by the cleaning blade 6 is provided, and the waste toner is transferred into a waste toner collection vessel, which is not shown in the figure. For supplying the toner 10, a toner cartridge 12 is detachably attached to this developing device 11.

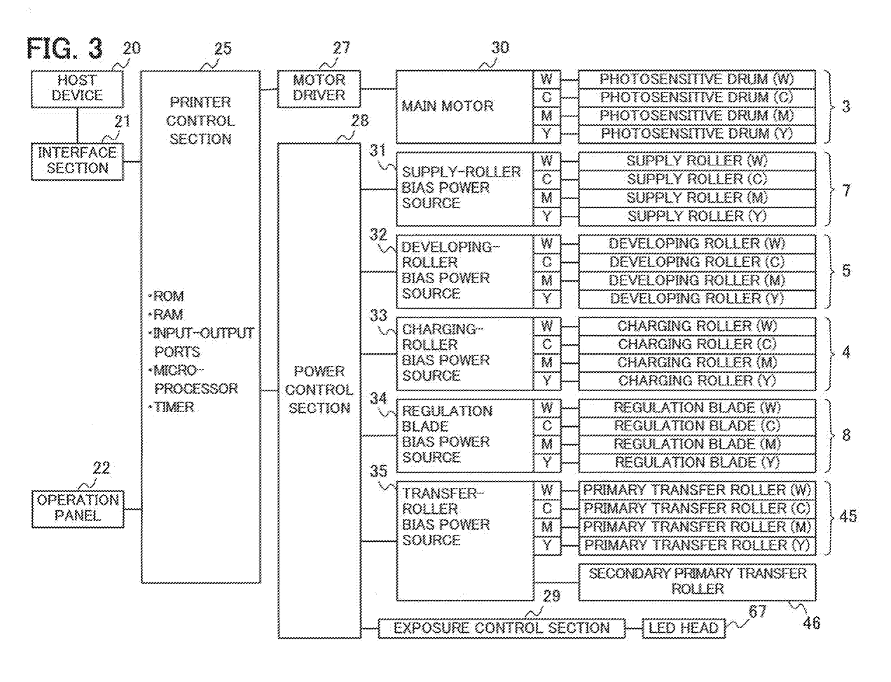

Each of the photosensitive drum 3, the developing roller 5, the supply roller 7, and the charging roller 4 rotates in the directions of arrows shown in FIG. 2. The photosensitive drum 3 is driven by a main motor 30 (shown in FIG. 3), which will be described later; driving power is transferred from the photosensitive drum 3 to the developing roller 5 by a gear not shown in the figures; and driving power is also transferred from the developing roller 5 to the supply roller 7 for rotation by an idle gear not shown in the figure. The charging roller 4 rotates following the photosensitive drum 3 because of contact with the photosensitive drum 3.

An LED head 67 as an exposing section includes, for example, LED elements and lens arrays, and is disposed in a position where light output from the LED elements forms an image on the surface of the photosensitive drum 3.

The intermediate transfer belt unit 40 includes a drive roller 41 driven by the main motor 30 (shown in FIG. 3), which will be described later, a tension roller 43 that applies tension to the intermediate transfer belt 44, a secondary transfer backup roller 42 that is disposed to face a secondary transfer roller 46 through the intermediate transfer belt 44 and forms a secondary transfer section 47, and an intermediate transfer belt 44 stretched by the rollers.

The intermediate transfer belt unit 40 further includes four primary transfer rollers 45Y, 45M, 45C, 45W (when each of them does not need distinguishing, each of them is denoted simply by a numeral 45) that are disposed to face the photosensitive drums 3 of the image forming units 61Y, 61M, 61C, 61W respectively through the intermediate transfer belt 44 and apply predetermined voltage to perform primary transfer of the toner images formed on the photosensitive drums 3 onto the intermediate transfer belt 44 one by one. The intermediate transfer belt unit 40 and the secondary transfer roller 46 correspond to a transfer section.

This intermediate transfer belt unit 40 performs primary transfer of the toner images formed by the image forming section 66 onto the intermediate transfer belt 44, as described above, and carries the primarily transferred toner images to the secondary transfer section 47. In the secondary transfer section 47, the secondary transfer roller 46 performs secondary transfer of the toner images that have been transferred onto the intermediate transfer belt 44 onto the recording paper 71 supplied from the paper cassette 15.

The toner that has not been transferred by the secondary transfer section 47 and has been left on the intermediate transfer belt 44 is removed by a transfer-belt cleaning member 49 and collected through a route not shown in the figures into a waste toner collection section 50. The intermediate transfer belt 44 is driven by the main motor 30 (FIG. 3), and the primary transfer rollers 45 rotate following the intermediate transfer belt 44 because of contact with the intermediate transfer belt 44.

A fixing device 62 includes an upper heating roller 62a that is driven to rotate in the direction of the arrow by a drive source not shown in the figures and a lower pressure roller 62b that is in contact with the upper heating roller 62a under presser and is rotated following the upper heating roller 62a. The fixing device 62 nips the sheet of the recording paper 71 from the secondary transfer section 47 by a nip part to carry it, applies heat and pressure to the toner image on the sheet of the recording paper 71 to melt the toner image in the carrying process, and fixes this melted toner image on the sheet of the recording paper 71. A pair of ejection rollers 63 ejects the printed sheet of the recording paper 71 out of the fixing device 62 to a stacker 72.

FIG. 3 is a block diagram illustrating a main-part configuration of a control system of the printer 1.

In the figure, a printer control section 25 includes a microprocessor, ROM, RAM, input-output ports, a timer or the like. The printer control section 25 receives print data and a control command from a host device 20, performs sequence control of the whole printer 1, and performs printing operation. An interface section 21 sends printer information to the host device 20, analyzes the command input from the host device 20, processes the data received from the host device 20, and provides the processed data to the printer control section 25.

In the ROM, a density correction table, which will be described later, and the like are recorded; in the RAM, density values and the like, which will be described later, related to the printing quality are recorded. An operation panel 22 allows a variety of print settings and system settings to be determined and input.

A motor driver 27 performs drive control of the main motor 30 for driving the rotation of the photosensitive drum 3 according to instructions from the printer control section 25. The rotation of the photosensitive drum 3 is transmitted to the developing roller 5 and the supply roller 7 by a gear transmission mechanism or the like, causing each part to rotate at its predetermined speed in the direction of the arrows shown in the figure as the photosensitive drum 3 rotates at a predetermined speed in the direction of the arrow, as shown in FIG. 2. The main motor 30 here drives and rotates the drive roller 41 of the intermediate transfer belt unit 40 at the same time.

A power control section 28 sets and changes bias voltages according to instructions from the printer control section 25. A supply-roller bias power source 31 applies direct-current constant voltage to the supply rollers 7 of (Y), (M), (C), and (W); a developing roller bias power source 32 applies direct-current constant voltage to the developing rollers 5 of (Y), (M), (C), and (W); a charging-roller bias power source 33 applies direct-current constant voltage to the charging rollers 4 of (Y), (M), (C), and (W); a regulation blade bias power source 34 applies direct-current constant voltage to the regulation blades 8 of (Y), (M), (C), and (W); a transfer-roller bias power source 35 applies direct-current constant voltage to the primary transfer rollers 45 and the secondary transfer roller 46 of (Y), (M), (C), (W); and the voltage values are controlled by the power control section 28.

An exposure control section 29 performs control operation for forming electrostatic latent images in accordance with the print data by having the LED heads 67 (FIG. 1) of (Y), (M), (C), (W) throw light to the surface of the charged photosensitive drums 3 they face.

In addition to the above, the printer control section 25 performs image processing, medium transfer control, fixing control, and the like, but the description of the control will be omitted here.

In the configuration as described above, the print processing operation by the printer 1 will be described with reference to FIGS. 1 to 3. The dotted arrow in FIG. 1 represents the transfer direction of the recording paper 71 to be carried.

In each image forming unit 61, the surface of the photosensitive drum 3 is charged uniformly at −500 V by the charging roller 4 to which the voltage of −1000 V is applied by the charging-roller bias power source 33. Then, the LED head 67 throws light selectively for exposure in accordance with the image data to the charged surface of the photosensitive drum 3 rotating in the direction of the arrow and forms an electrostatic latent image on the surface by making the exposed section −50 V.

The voltage of −300 V is applied to the supply roller 7 by the supply-roller bias power source 31 and the supply roller 7 supplies the toner 10 onto the developing roller 5. The toner on the developing roller 5 is charged at substantially −25 μC/g and formed into a thin layer by friction or the like with the regulation blade 8. Then the toner on the developing roller 5 adheres to the electrostatic latent image due to the difference of potential between the developing roller 5 to which the voltage of −200 V is applied by the developing-roller bias power source 32 and the electrostatic latent image on the photosensitive drum 3 to develop the electrostatic latent image. The toner 10 on the developing roller 5 that are left undeveloped is scraped off by the supply roller 7. In this manner, a toner image is formed on the surface of the photosensitive drum 3.

When the toner image formed on each photosensitive drum 3 passes the transfer position in contact with the intermediate transfer belt 44, the primary transfer roller 45 to which the voltage of +1500 V is applied by the transfer-roller bias power source 35 causes primary transfer of the image onto the intermediate transfer belt 44. The timings of forming the toner images on the photosensitive drums 3 are controlled so that the toner images of different colors to be transferred to the intermediate transfer belt 44 are sequentially transferred one by one onto the intermediate transfer belt 44 so as to be layered. In this step, a color image is formed by the layered toner images of yellow (Y), magenta (M), cyan (C), and white (W) on the intermediate transfer belt 44.

In parallel with the color image formation onto the intermediate transfer belt 44 described above, a sheet of the recording paper 71 set in the paper cassette 15 is taken out of the paper cassette 15 by the hopping roller 16 and carried to the secondary transfer section 47 with the skew corrected by the pair of resist rollers 17. In the secondary transfer section 47, when the sheet of the recording paper 71 passes through the part between the secondary transfer roller 46 and the secondary transfer backup roller 42 that nip the intermediate transfer belt 44, the secondary transfer of the color image on the intermediate transfer belt 44 to a position on the recording paper 71 is performed by the secondary transfer roller 46 to which the voltage of +2000 V is applied by the transfer-roller bias power source 35.

The values of voltage applied by the supply-roller bias power source 31 to the transfer-roller bias power source 35 are given as examples and should be set as needed in accordance with the conditions.

The sheet of the recording paper 71 having a color image formed by the toner images of different colors transferred onto the surface is then carried to the fixing device 62 by a carrying means which is not shown in the figure. The toner images on the recording paper 71 are melted under heat and pressure applied by the fixing device 62 and fixed onto the sheet of the recording paper 71. The sheet of the recording paper 71 with the fixed toner images is ejected to the stacker 72 outside the apparatus by the pair of ejection rollers 63, and the print processing operation ends. After the sheet of the recording paper 71 is separated, the intermediate transfer belt 44 is cleaned by the transfer-belt cleaning member 49 that removes toner or other things left on the belt.

An example of T-shirt printing that transfers the toner images formed by the printer 1 will next be described.

To perform T-shirt printing, the toner images are first transferred to an M-sheet as a first transfer sheet by the printer 1, the toner images on the M-sheet is transferred to a T-sheet as a second transfer sheet by ironing. Then the toner images on the T-sheet are transferred from the T-sheet to a T-shirt by the iron. Here, an M-sheet of WoW 7.7-Dark T-shirt Transfer Paper of TheMagicTouch Ltd. is used; a T-sheet of WoW 7.7-Dark T-shirt Transfer Paper of TheMagicTouch Ltd. is used; and a heat press model HTP234PS1 of TheMagicTouch was used as the iron.

The toner used for this T-shirt printing is a fluorescent toner, which is made by adding external additives such as inorganic microparticles or organic microparticles to toner base particles containing at least binder resin.

As that binder resin, polyester resin, styrene-acrylic resin, epoxy resin, or a styrene-butadiene resin is preferred, but that binder resin is not limited to these. To that binder resin, a release agent, a coloring agent, and the like are added, and in addition to these agents, additives such as an electrification control agent, an electroconductivity modifying agent, a fluidity improving agent, or a cleaning-ability improving agent could be added as needed. The binder resin can be a mixture of multiple types, and in this embodiment, a polyester resin having a crystal structure was used in addition to a plurality of amorphous polyester resins.

In the present invention, base particles made by a crushing method as a making method are used. The crushing method is a making method for obtaining toner base particles of a predetermined particle diameter by making a mass of toner base particles in advance through melting and kneading materials other than external additives, such as a binder resin, a release agent, and electrification control agent, by using, for example, an extruder or a two-axis kneader, cooling it, coarse-crushing it by a cutter mill or the like, crushing it further by a collision-type crusher, and then classifying it by an air classifier or the like.

It is used as the release agent, a known agent such as low molecular weight polyethylene; low molecular weight polypropylene; olefin copolymer; aliphatic hydrocarbon wax such as microcrystalline wax, paraffin wax, or Fischer-Tropsch wax; an oxide of aliphatic hydrocarbon wax such as oxidized polyethylene wax; their block copolymer; carnauba wax; wax consisting primarily of fatty acid ester such as montanic acid ester wax; agents such as deoxidized carnauba wax obtained by deoxidizing fatty acid esters partially or completely, but the release agent is not limited to one of these known agents. As for the content, adding 0.1 to 20 PHR, or preferably 0.5 to 12 PHR, of the agent to 100 PHR of the binder resin is effective, and using a plurality of waxes is also preferred.

As the coloring agent of the fluorescent yellow toner, the SX-100 series and SX-1000 series of SINLOIHI CO., LTD. can be used, and colored resin particles, which are resin dyes with fluorescent dye dispersion, such as SX-105 Lemon Yellow and SX-106 Orange Yellow of the SX-100 series and SX-1005 Lemon Yellow of the SX-1000 series can be used, but the coloring agent of the fluorescent yellow toner is not limited to those.

As the coloring agent of the fluorescent magenta toner, the SX-100 series and SX-1000 series of SINLOIHI CO., LTD. can be used, and resin pigments such as SX-101 Red Orange, SX-103 Red, SX-104 Orange, SX-117 Pink, SX-127 Rose of the SX-100 series and SX-1004 Orange, SX-1007 Pink, SX-1037 Magenta of the SX-1000 series can be used, but the coloring agent of the fluorescent magenta toner is not limited to those.

As the coloring agent of the fluorescent cyan toner, dyes, pigments, or the like used as coloring agents for the conventional fluorescent cyan toner can be used singly or concurrently in combination, but the coloring agent of the fluorescent cyan toner is not limited to those. For example, phthalocyanine blue, Pigment Green B, Pigment Blue 15:3, Solvent Blue 35, can be used.

As the coloring agent of the fluorescent white toner, dyes, pigments, and the like used as the coloring agent for the conventional fluorescent white toner can be used singly or concurrently in combination, but the coloring agent of the fluorescent cyan toner is not limited to those. For example, titanium oxide or the like can be used.

As for the content, 2 to 25 PHR, or preferably 2 to 15 PHR, of the coloring agent described above is added to 100 PHR of the binder resin. For the fluorescent cyan toner and the fluorescent white toner, in addition to the coloring agent described above, 2 to 25 PHR, preferably 2 to 15 PHR, of a fluorescent whitening agent such as a stilbene compound, coumarin compound, and biphenyl compound is added to 100 PHR of the binder resin, to give fluorescence.

As the electrification control agent, a known agent can be used. For example, for negatively charged toner, an azo-based complex electrification control agent, salicylic acid based complex electrification control agent, Calixarene electrification control agent or the like can be used. As for the content, 0.05 to 15 PHR of this electrification control agent is added to 100 PHR of the binder resin, and here, 1.0 PHR of BONTRON P-51 (of ORIENT CHEMICAL INDUSTRIES CO., LTD.) is added as the electrification control agent, to the fluorescent cyan toner, the fluorescent magenta toner, the fluorescent yellow toner, and the fluorescent white toner.

The external additives are added to improve environmental stability, charging stability, developing property, fluidity, preserving property, and known external additives can be used. As for the content, 0.01 to 10 PHR, preferably 0.05 to 8 PHR of the external additive is added to 100 PHR of the binder resin.

In this embodiment, 3.0 PHR of hydrophobic silica R972 (of NIPPON AEROSIL CO., LTD., average particle diameter is 16 nm) is added as an external additive to 1 kg of base particle (100 PHR), is stirred by a Henschel mixer, and is adhered to the toner base particles. This is created for each of the fluorescent cyan toner, the fluorescent magenta toner, the fluorescent yellow toner, and the fluorescent white toner. The specific gravity of all the toners used in this embodiment ranges from 0.34 to 0.36 mg/cm².

The apparent density of the fluorescent white toner is 0.55 to 0.60 g/cm³, and the apparent density of the toner containing a fluorescent colorant or a fluorescent whitening agent, except the fluorescent white toner, is 0.34 to 0.36 g/cm³.

Next, a T-shirt printing evaluation test will be described which is conducted to examine problems such as adhesive residue and white void in T-shirt printing by using fluorescent toner as a plurality of kinds of developer that contain the components stated above and are different at least in either gel fraction or melting-point temperature (T½).

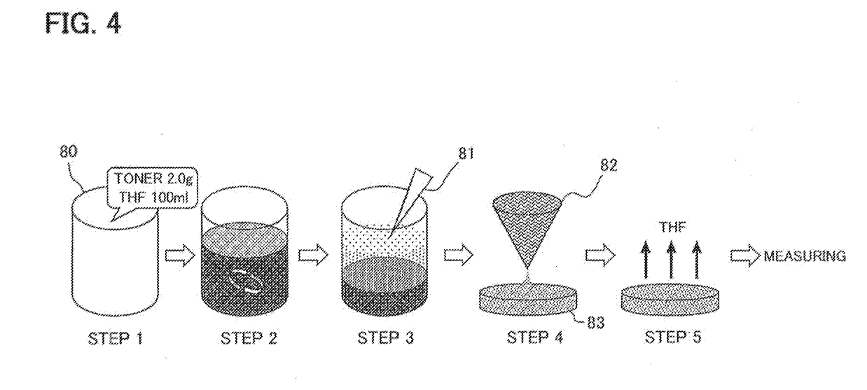

The gel fraction measurement method will be described here with reference to FIG. 4. FIG. 4 is a diagram schematically illustrating the processing in the measurement steps of gel fraction measurement of the toner.

The gel fraction measurement was carried out in steps 1 to 6 below.

1. 2.0 g of toner and 100 ml of tetrahydrofuran (hereafter THF) as a solvent were put into a 100-ml glass bottle 80 (see step 1 in FIG. 4).

2. Those were stirred for six hours (500 rpm) in an indoor environment (temperature: 22° C.; humidity: 55%) (see step 2 in FIG. 4).

3. Those were left at rest for 20 hours, then 20 ml of supernatant fluid was obtain by using a pipette 81 (see step 3 in FIG. 4).

4. Liquid filtered through a filter paper 82 was collected into a petri dish 83 which has known weight (see step 4 in FIG. 4).

5. The petri dish was left in a draft for four hours and then left it for four hours in a vacuum drier which provides an environment with a temperature of 60° C., to take away THF (see step 5 in FIG. 4).

6. The weight of the petri dish was measured, and the weight of the soluble substances was calculated by using the expression given below to obtain the gel fraction.

Gel fraction [%]=100−((Weight of petri dish after drying−Weight of petri dish before drying)/0.4×100)

In the expression given above, (Weight of petri dish after drying−Weight of petri dish before drying) was divided by 0.4, because (Weight of petri dish after drying−Weight of petri dish before drying) was obtained from 0.4 g of the toner.

The melting-point temperature (T½(° C.)) was measured by using a flow tester (CFT-500D of SHIMADZU CORPORATION) under the following conditions:

Test mode: Temperature rise method

Starting temperature: 50° C.

Achieving temperature: 200° C.

Temperature increase rate: 3° C./min

Measurement interval: 1/° C.

Preheating time: 300 s

Full scale stroke: 20 (15*) mm

Full scale time: 3000 s

Die diameter: 1 mm

Die length: 1 mm

Weight: 10 kg

Melting-point temperature measurement: ½ method

Offset value: -

Piston area: 1 cm²

By measuring the gel fraction and the melting-point temperature as described above, a plurality kinds of fluorescent toner C1 to C9 listed below were prepared as test samples for the T-shirt printing evaluation test. The fluorescent toner for each of the test samples is prepared for each of the four colors (Y), (M), (C), and (W) in the same manner, and each of them was tested in the method described later. By varying a toner manufacturing condition, such as the blend ratio of the binder resin, properties such as the gel fraction and the melting-point temperature can be changed.

Fluorescent toner C1: Gel fraction 57.1%, melting-point temperature (T½) 149.4° C.

Fluorescent toner C2: Gel fraction 55.4%, melting-point temperature (T½) 131.9° C.

Fluorescent toner C3: Gel fraction 69.0%, melting-point temperature (T½) 129.6°

Fluorescent toner C4: Gel fraction 12.4%, melting-point temperature (T½) 109.4°

Fluorescent toner C5: Gel fraction 8.1%, melting-point temperature (T½) 132.2° C.

Fluorescent toner C6: Gel fraction 12.4%, melting-point temperature (T½) 129.6° C.

Fluorescent toner C7: Gel fraction 8.1%, melting-point temperature (T½) 129.6° C.

Fluorescent toner C8: Gel fraction 57.1%, melting-point temperature (T½) 129.6°

Fluorescent toner C9: Gel fraction 8.1%, melting-point temperature (T½) 149.4° C.

Each of the test samples of C1 to C9 described above is used and printed to an M-sheet under the conditions described below and in the steps described below, and test-printed M-sheets were obtained.

(1) It is assumed that a test printer having basically the same structure as the printer 1 shown in FIG. 1 is used in the test and that the value of voltage applied to each section by the power control section 28 is also set to the same value as the printer 1.

(2) Single color printing was performed. A process of eliminating the influence of the image forming unit not in use was carried out.

(3) In the printing environment, the temperature was set to 22° C., and the humidity was set to 55%.

(4) The printing speed of the test printer (=linear velocity on the outer circumference of the photosensitive drum 3) was set to 58.7 (mm/sec).

(5) As the M-sheet to be printed on, the M-sheet of WoW 7.7-Dark T-shirt Transfer Paper of TheMagicTouch Ltd. was used here.

(6) Each of the test samples C1 to C9 is printed on a single M-sheet by the test printer the same as the printer 1, with a solid 100% duty pattern (printing the entire printable range of A4 paper to fill in all the area, that is, printing to an area ratio of 100% is expressed as solid 100% duty).

(7) The density of each of the solid 100% duty patterns printed with each of the test samples C1 to C9 on the M-sheets is measured.

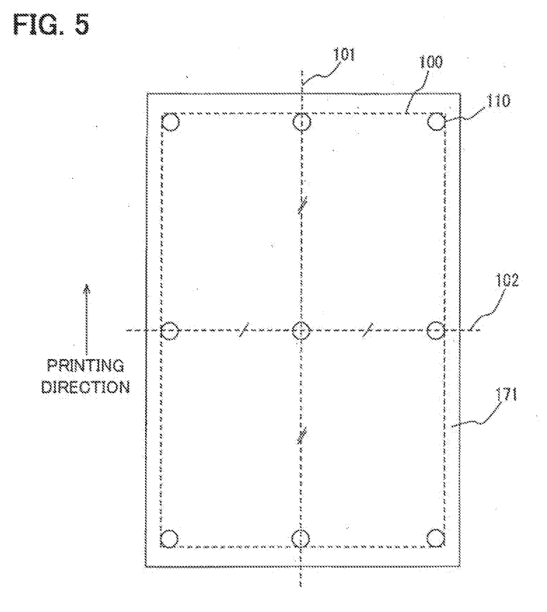

This density measurement method will be described with reference to FIG. 5. FIG. 5 is a diagram illustrating the measurement positions of the solid 100% duty pattern on the M-sheet 17 as a printing medium.

In the figure, measurement was made with an x-rite spectral density meter at the measurement positions (nine circled positions in FIG. 5) which were located at the intersection points or the near points of the intersection points, where any two lines of printing range lines 100 of dotted lines indicating the rectangular printable range, a first parting line 101 (dotted line) extending in the printing direction to divide the printable range into two equal parts, and a second parting line 102 (dotted line) extending in the direction perpendicular to the printing direction to divide the printable range into two equal parts are crossed, and the mean value was calculated. All the densities (O.D values) of the fluorescent toner C1 to C9 were 1.00. The thickness of the layers of the fluorescent toner C1 to C9 was 0.40 mg/cm².

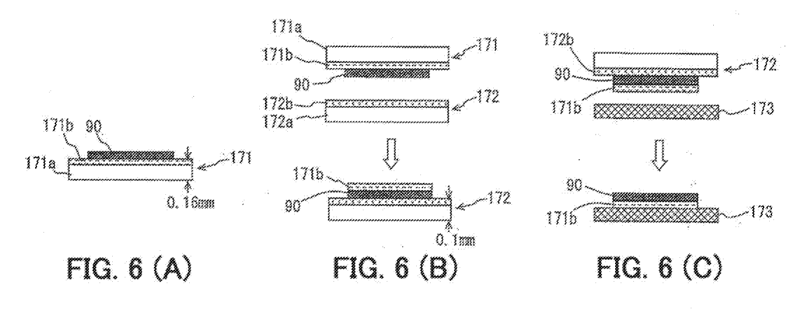

The test samples of the toner C1 to C9 were used for printing in the method described above, and obtained test-printed M-sheets were used for T-shirt printing with a manual heat press. FIGS. 6(A) to 6(C) illustrate diagrams provided to explain a T-shirt printing procedure. The T-shirt printing procedure will be described with reference to the figure. The heat press used in the process was a heat press model HTP234PS1 manufactured by TheMagicTouch Ltd.

(8) A toner image 90 was transferred and fixed onto the M-sheet 171 by the test printer, as described earlier. As shown in FIG. 6(A), the M-sheet 171 has an adhesive layer 171b formed on a paper sheet 171a in order for subsequent adhesion to the T-shirt, and the toner image 90 was fixed on the adhesive layer 171b. The thickness of this M-sheet 171 is 0.16 mm.

(9) The T-sheet 172 used here was the T-sheet of WoW 7.7-Dark T-shirt Transfer Paper of TheMagicTouch Ltd. The thickness of this T-sheet 172 is 0.10 mm.

(10) Then, the toner image 90 was transferred from the test-printed M-sheet 171 to the T-sheet 172, as shown in FIG. 6(B). The transferring conditions here were that the M-sheet was pressed to the T-sheet 172 by the heat press at pressing temperature of 135° C. for 45 seconds. The T-sheet 172 has a release layer 172b of an oil and fat material such as wax, which improve the releasing property, on a paper sheet 172a in order to peel off later. The toner image 90 and the adhesive layer 171b were transferred on the release layer 172b in that order.

If the melting-point temperature (T½) of the toner is not appropriate, the toner of the toner image 90 and the adhesive layer 171b would be mixed together unnecessarily and induce the problem (adhesive residue) of leaving the toner on the paper sheet 171a of the M-sheet 171. The adhesive residue generated here was evaluated on a ten-point scale: a rating of 8 or above that would cause no problem to be visually recognized was marked with A (Acceptable), and a rating below 8 was marked with N (Not acceptable).

(11) Then, as shown in FIG. 6(C), the adhesion force of the adhesive layer 171b was used to transfer the toner image 90 from the T-sheet 172 to the T-shirt 173. The transferring conditions here were that the T-sheet 172 was pressed to the T-shirt 173 by the heat press at pressing temperature of 135° C. for five seconds. Here, a common 100% cotton (generic) T-shirt was used. If the gel fraction of the toner is not appropriate, the adhesion force between the toner interface and the interface of the T-shirt 173 would become uneven and induce the problem (white void) of transferring the toner image 90 incompletely onto the T-shirt 173 and leaving void dots in the toner image. The white void generated here was evaluated on a ten-point scale: a rating of 8 or above that would cause no problem to be visually recognized was marked with A, and a rating below 8 was marked with N.

As the pressing temperatures and pressing periods in and after (10), values designated by TheMagicTouch Ltd. were used. The used values are standard set values for WoW 7.7-Dark M-shirt Transfer Paper or WoW 7.7-Dark T-shirt Transfer Paper of TheMagicTouch Ltd. used here.

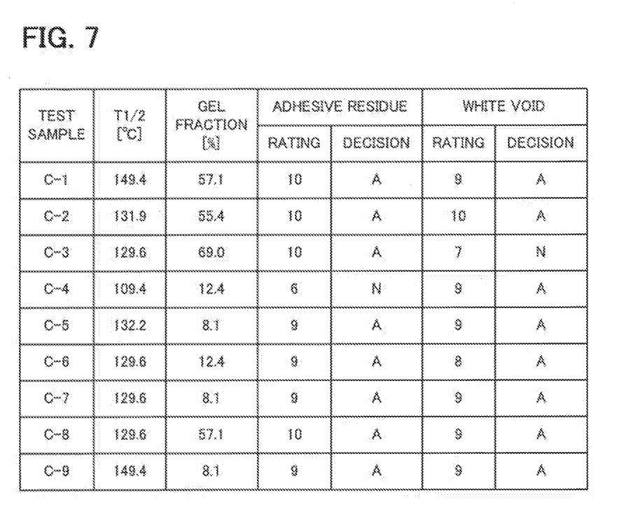

FIG. 7 is a diagram representing a table 1 listing the evaluation results.

As indicated by the table 1, the melting-point temperature T½ [° C.] of the toner and the adhesive residue level have a correlation with each other: the higher T½ [° C.] is, the better the adhesive residue level is. It is thought that the excessively low toner melting point T½[° C.] would cause excessive melting in heat pressing, cause the adhesive of the adhesive layer 171b of the M-sheet 171 for T-shirt printing to be mixed with the toner unnecessarily, and induce adhesive residue in which the toner is left on the paper sheet 171a of the M-sheet 171.

The gel fraction [%] of the toner and the white void level also have a correlation with each other: if the gel fraction [%] is too high, the white void level worsens. The gel fraction [%] indicates the percentage of cross-linked polymers included in the toner resin; if the gel fraction [%] is high, it is more cross-linked than a polymer of the same molecular weight, so that it hardly melt even at a high temperature. Therefore, it is thought that an excessively high gel fraction [%] would make the adhesion force between the toner interface and the interface of the T-shirt 173 uneven in heat pressing, cause the toner image 90 to be transferred incompletely onto T-shirt 173 and induce the white void that makes void dots in the toner image on the T-shirt.

These test results were common to each kind of the fluorescent toner of yellow (Y), magenta (M), cyan (C), and white (W).

According to the results indicated in the table 1, it is found that when T½ [° C.] is in the range of 129.6° C.≤T½≤149.4° C., the occurrence of adhesive residue was suppressed and good printing was obtained and that when gel fraction [%] is in the range of 8.1%≤gel fraction≤57.1%, the occurrence of white void was suppressed and good printing was obtained.

Therefore, by printing on the M-sheet with fluorescent toner T½ [° C.] of which is in the range of 129.6° C.≤T½≤149.4° C. and the gel fraction [%] of which is in the range of 8.1%≤gel fraction≤57.1%, the occurrence of adhesive residue and white void can be suppressed, and good printing can be made on special media such as T-shirts.

In the embodiment described above, an example of applying the present invention to an electro photographic color printer has been described, but the embodiment does not limited to the example. The embodiment can be applied to black-and-white printers, multi-function printers (MFPs), facsimiles, label making machines, copiers, and the like.

1. A developing device comprising:
developer that includes toner containing binder resin;
a developer container that contains the developer; and
a developer carrier that carries the developer and supplies the developer to an image carrier; wherein
the developer has melting-point temperature (T½) in the range of 129.6° C.≤T½≤149.4° C. and a gel fraction in the range of 8.1%≤gel fraction≤57.1%.

2. The developing device of claim 1, wherein the gel fraction is measured by using substances, the substances being obtained by drying liquid, the liquid being obtained by filtering the toner dissolved in tetrahydrofuran.

3. The developing device of claim 1, wherein the toner contains at least one of a fluorescent colorant and a fluorescent whitening agent.

4. The developing device of claim 1, wherein
the toner is white toner; and
the white toner contains a fluorescent whitening agent and titanium oxide.

5. The developing device of claim 4, wherein
the apparent density of the white toner is 0.55 to 0.60 g/cm³.

6. The developing device of claim 3, wherein
the apparent density or the toner is 0.34 to 0.36 g/cm³.

7. An image forming apparatus comprising:
the developing device of claim 1;
the image carrier of claim 1, the image carrier allowing a latent image to be formed and carrying a toner image;
a charging member that charges the surface of the image carrier;
an exposing section that forms the latent image on the charged image carrier;
a transfer section that transfers the toner image from the image carrier; and
a fixing device that fixes the developer image.

8. The image forming apparatus of claim 7, wherein
the transfer section performs primary transfer of the toner image from the image carrier to an intermediate transfer belt member and secondary transfer of the toner image from the intermediate transfer belt member to a recording medium.
